(19) United States
(12) Patent Application Publication
(10) Pub. No.: US 2026/0338556 A1
(43) Pub. Date: Oct. 29, 2026

(54) NAVIGATION ASSISTANCE DEVICE AND NAVIGATION ASSISTANCE DATA GENERATION METHOD

(71) Applicant: Furuno Electric Co., Ltd., Nishinomiya (JP)

(72) Inventor: Koji NISHIYAMA, Toyonaka (JP)

(21) Appl. No.: 19/703,488

(22) Filed: Jun. 10, 2026

Related U.S. Application Data
(63) Continuation of application No. PCT/JP2024/041493, filed on Nov. 22, 2024.

(30) Foreign Application Priority Data
Dec. 14, 2023 (JP) 2023-211002

(51) Int. Cl. G01C 21/20; G06T 7/73; G06T 11/23

(52) U.S. Cl. CPC G01C 21/203; G06T 7/73; G06T 11/23; G06T 2207/30261

(57) ABSTRACT

A navigation assistance device includes processing circuitry configured to: generate surrounding image data of a hull including a ship's side of the hull and a water surface outside the ship's side; generate AR data including grid image data having multiple first grid lines arranged parallel to the ship's side and spaced apart from each other; and combine the AR data and the surrounding image data such that the multiple first grid lines are arranged with the ship's side as a reference in a region corresponding to the water surface.

### CROSS-REFERENCE TO RELATED APPLICATION(S)

This application is a continuation application of PCT International Application No. PCT/JP2024/041493, which was filed on Nov. 22, 2024, and which claims priority to Japanese Patent Application No. JP2023-211002 filed on Dec. 14, 2023, the entire disclosures of each of which are herein incorporated by reference for all purposes.

### TECHNICAL FIELD

The present disclosure relates to AR technology for ships.

### BACKGROUND

Conventional art describes a system that superimposes boundary line display data of a passage route on captured image data of an area in front of a ship.

However, when a hull departs from or approaches a quay, the distance to the quay could not be easily visually recognized.

### SUMMARY

Therefore, an object of the present invention is to generate an image that allows easy visual recognition of the distance to a quay.

A navigation assistance device according to one aspect of the present invention includes processing circuitry configured to: generate surrounding image data of a hull including a ship's side of the hull and a water surface outside the ship's side; generate AR data including grid image data having multiple first grid lines arranged parallel to the ship's side and spaced apart from each other; and combine the AR data and the surrounding image data such that the multiple first grid lines are arranged with the ship's side as a reference in a region corresponding to the water surface.

With this configuration, grid lines based on the hull are superimposed and displayed over an image around the hull. Accordingly, for example, the distance to a quay shown in the image can be easily visually recognized.

In the navigation assistance device according to one aspect of the present invention, the processing circuitry spaces the multiple first grid lines at equal intervals.

In the navigation assistance device according to one aspect of the present invention, the processing circuitry is further configured to detect an actual ship speed of the hull in an Earth coordinate system. The processing circuitry sets an interval between the multiple first grid lines, based on the actual ship speed.

In the navigation assistance device according to one aspect of the present invention, the processing circuitry is further configured to: specify a specific position outside the hull; and calculate an actual distance between the specific position in an Earth coordinate system and the ship's side. The processing circuitry sets an interval between the multiple first grid lines, based on the actual distance.

In the navigation assistance device according to one aspect of the present invention, the processing circuitry generates the grid image data to have the multiple first grid lines and multiple second grid lines arranged orthogonal to the ship's side and spaced apart from each other. The processing circuitry combines the grid image data and the surrounding image data such that the multiple second grid lines are arranged forward of a bow of the hull with the bow as a reference, in the region corresponding to the water surface.

In the navigation assistance device according to one aspect of the present invention, the processing circuitry combines the grid image data and the surrounding image data such that the multiple second grid lines are arranged rearward of a stern of the hull with the stern as a reference, in the region corresponding to the water surface.

In the navigation assistance device according to one aspect of the present invention, the processing circuitry makes an interval between the multiple first grid lines and an interval between the multiple second grid lines the same.

In the navigation assistance device according to one aspect of the present invention, the processing circuitry makes an interval between the multiple first grid lines different from an interval between the multiple second grid lines.

### BRIEF DESCRIPTION OF THE DRAWINGS

The present disclosure is illustrated by way of example and not by way of limitation in the figures of the accompanying drawings, in which like reference numerals indicate like elements and in which:

FIG. 1 is a functional block diagram showing an example of the configuration of a navigation assistance system including a navigation assistance device according to an embodiment of the present invention.

FIG. 2A and FIG. 2B are diagrams showing an example of placement of cameras with respect to a hull.

FIG. 3 is a flowchart showing an example of a method for generating surrounding image data.

FIG. 4A and FIG. 4B are flowcharts showing specific examples of stitching image data.

FIG. 5 is a diagram showing an example of setting the outer shape of the hull used for stitching image data.

FIG. 6 is a diagram showing an example of setting a boundary for stitching image data.

FIG. 7A is a diagram showing an example of a surrounding image according to the configuration of the present application, and FIG. 7B is a diagram showing an example of a surrounding image (comparative surrounding image) according to a comparative example (conventional configuration).

FIG. 8 is a flowchart showing an example of a method for calculating the shortest distance between a designated position and the hull and a method for displaying the shortest distance.

FIG. 9 is a flowchart showing an example of a specific method for calculating the shortest distance between the designated position and the hull.

FIG. 10 is a diagram illustrating the concept of calculating the shortest distance.

FIG. 11A and FIG. 11B are diagrams showing examples of an image using composite image data including the shortest distance.

FIG. 12 is a diagram showing an example of an image based on composite image data when multiple designated positions are designated.

FIG. 13 is a flowchart showing an example of a method for correcting a designated position.

FIG. 14 is a diagram illustrating the concept of correcting a designated position.

FIG. 15A is a composite image before movement of the hull, FIG. 15B is a composite image after movement of the hull when the configuration of the present application is used, and FIG. 15C is a composite image after movement of the hull when the configuration of the present application is not used (in the case of the conventional configuration).

FIG. 16 is a flowchart showing an example of a method for generating a grid line image.

FIG. 17 is a flowchart showing an example of a specific method for generating grid lines.

FIG. 18 is a diagram illustrating the concept of setting grid lines.

FIG. 19 is a diagram showing an example of a composite image including grid lines.

FIG. 20 is a diagram showing an example of a composite image including grid lines.

FIG. 21 is a diagram showing an example of a composite image.

### DETAILED DESCRIPTION

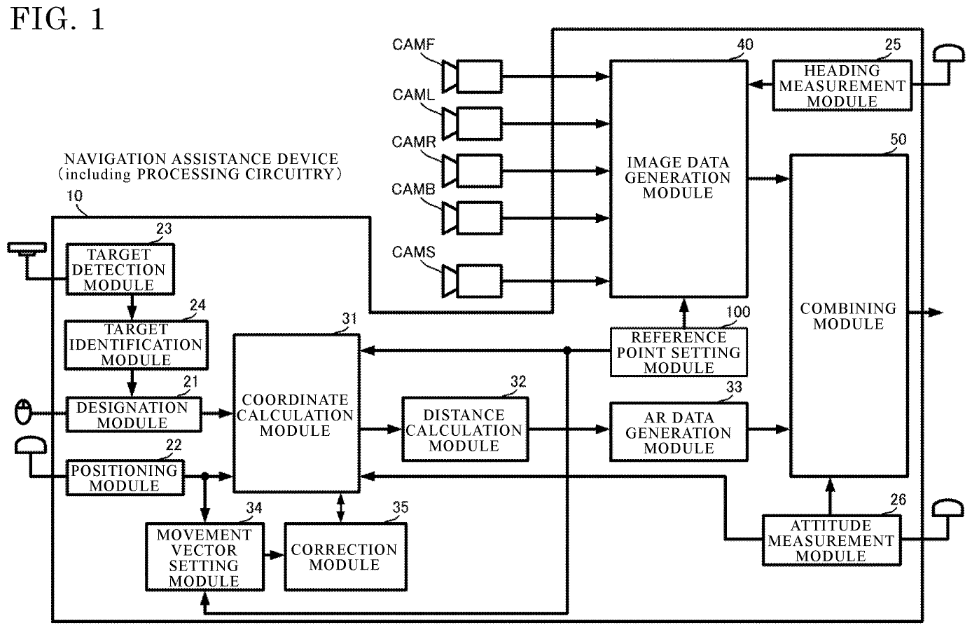

A navigation support technology according to an embodiment of the present invention will be described with reference to the drawings. FIG. 1 is a functional block diagram showing an example of the configuration of a navigation assistance system including a navigation assistance device according to the embodiment of the present invention.

The navigation assistance system may include a navigation assistance device 10, a bow camera CAMF, a port side camera CAML, a starboard side camera CAMR, a stern camera CAMB, and a forward monitoring camera CAMS.

The navigation assistance device 10 may include a designation module 21, a positioning module 22, a target detection module 23, a target identification module 24, a heading measurement module 25, an attitude measurement module 26, a coordinate calculation module 31, a distance calculation module 32, an AR data generation module 33, a movement vector setting module 34, a correction module 35, an image data generation module 40, a combining module 50, and a reference point setting module 100. Each of these functional modules constituting the navigation assistance device 10 may be realized by processing of a controller. The controller may be composed of hardware or software and may be referred to as processing circuitry. In other words, a navigation assistance program may be stored in the navigation assistance device 10 or the like, and the controller may realize the functions of the aforementioned functional modules by executing the navigation assistance program.

The configuration shown in FIG. 1 may be the configuration necessary when the navigation assistance device 10 executes all of the multiple types of functions described later, and the minimum configuration when executing each function individually may be only a part of the configuration shown in FIG. 1 depending on the function.

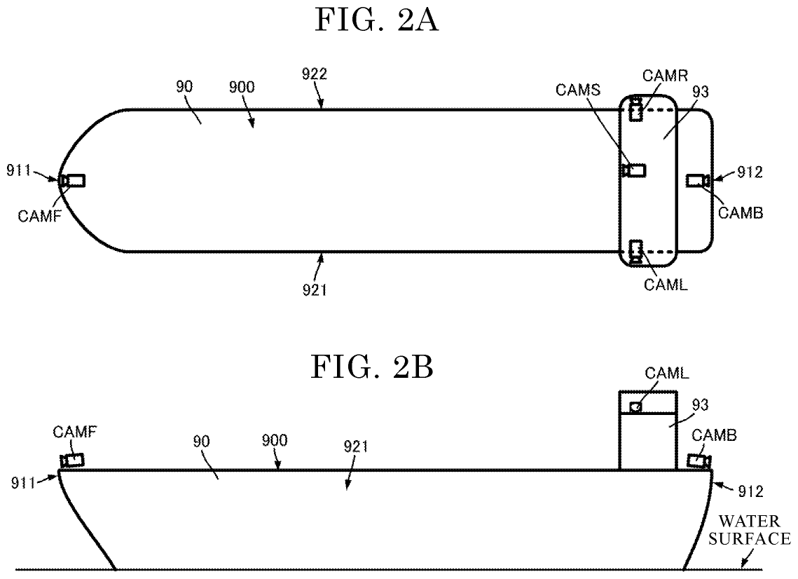

FIG. 2A and FIG. 2B are diagrams showing an example of placement of cameras with respect to a hull. FIG. 2A is a plan view, and FIG. 2B is a side view seen from the port side.

A hull 90 may include a bow 911, a stern 912, a port side 921, a starboard side 922, a deck 900, and a bridge 93. The bridge 93 may be placed on the hull 90 at a position closer to the stern 912 than to the bow 911, for example, near the stern 912 at a predetermined height.

The bow camera CAMF, the port side camera CAML, the starboard side camera CAMR, the stern camera CAMB, and the forward monitoring camera CAMS may be connected to the image data generation module 40.

The bow camera CAMF, the port side camera CAML, the starboard side camera CAMR, and the stern camera CAMB may each be composed of a fisheye camera. For example, the horizontal and vertical fields of view of the bow camera CAMF, the port side camera CAML, the starboard side camera CAMR, and the stern camera CAMB may be 180° or more, specifically about 240°. The fields of view are examples and may be 180° or more.

The bow camera CAMF may be placed near the bow 911, forward of the bridge 93 on the deck 900. The bow camera CAMF may capture images in the bow direction of the hull and generate bow image data PICF. The bow camera CAMF may output the bow image data PICF to the image data generation module 40.

The stern camera CAMB may be placed near the stern 912, rearward of the bridge 93 on the deck 900. The stern camera CAMB may capture images in the stern direction of the hull and generate stern image data PICB. The stern camera CAMB may output the stern image data PICB to the image data generation module 40.

The port side camera CAML may be placed at a high position in the bridge 93 (for example, at the same height as a wheelhouse). The port side camera CAML may capture images in the port side direction of the hull and generate port side image data PICL. The port side camera CAML may output the port side image data PICL to the image data generation module 40.

The starboard side camera CAMR may be placed at a high position in the bridge 93 (for example, at the same height as the wheelhouse). The starboard side camera CAMR may capture images in the starboard side direction of the hull and generate starboard side image data PICR. The starboard side camera CAMR may output the starboard side image data PICR to the image data generation module 40.

Since the port side camera CAML and the starboard side camera CAMR may be positioned higher than the bow camera CAMF and the stern camera CAMB, the port side camera CAML and the starboard side camera CAMR can capture images of the water surface near the bow 911 and the water surface near the stern 912. In particular, since the bow 911 may also be distant from the bridge 93 in the horizontal direction, images of the water surface near the bow 911 can be captured more reliably.

The forward monitoring camera CAMS may capture higher-resolution images with a narrower field of view than the bow camera CAMF.

The forward monitoring camera CAMS may be placed in a forward position at a high position in the bridge 93. The forward monitoring camera CAMS may capture images of the front, including the bow 911, and generate forward monitoring image data. The forward monitoring camera CAMS may output the forward monitoring image data to the image data generation module 40.

A virtual space may be set for such a hull 90. A reference point in the virtual space may be set by the reference point setting module 100. The reference point in the virtual space may be the position of a virtual camera and may be, for example, set within the bridge 93. More specifically, when viewing the hull 90 in a plan view (at rest), the reference point in the virtual space (the position of the virtual camera) may be set between the bow camera CAMF and the stern camera CAMB in the fore-aft direction and may be set between the port side camera CAML and the starboard side camera CAMR in the port-starboard direction. Furthermore, it is preferable that the reference point in the virtual space (the position of the virtual camera) is set at the installation position of the forward monitoring camera CAMS.

The virtual space may be set, for example, corresponding to an Earth coordinate system. The virtual space may be set in a three-axis coordinate system with one coordinate axis representing the latitude direction, one coordinate axis representing the longitude direction, and one coordinate axis representing the vertical direction, in the Earth coordinate system. This allows the position coordinates, speeds, and headings of other ships acquired by AIS or the like to be easily set on the virtual space.

The virtual space may be configured, for simplifying calculations, by two horizontal axes representing a local tangent plane on the Earth (a large ellipsoid) and a vertical axis perpendicular to the tangent plane. In such a virtual space, the latitude and longitude difference between a past position and a current position of the own ship used for distance measurement can be handled by regarding, for example, a value obtained by a linear approximation formula using Hubeny's formula as a value on a plane in the virtual space. In other words, since the Earth is extremely large compared to the range observable by the navigation assistance device 10 (a radius of about 1 NM, which is the measurable distance), the use of this approximation can, in practice, still achieve sufficient accuracy in the virtual space.

In addition, the coordinate system of the virtual space and the hull coordinate system can be transformed based on the heading of the hull 90 measured by the heading measurement module 25.

The image data generation module 40 may stitch the bow image data PICF, the port side image data PICL, the starboard side image data PICR, and the stern image data PICB to generate surrounding image data that shows the surroundings of the hull 90. At this time, it is preferable that the surrounding image data is an image including the bow 911, the stern 912, the port side 921, and the starboard side 922 of the hull 90. The image data generation module 40 may output the surrounding image data to the combining module 50.

The image data generation module 40 may generate surrounding image data using the reference point in the virtual space as a reference point in an image. Therefore, the positional relationship between the coordinate system of the virtual space and each pixel of the image based on the surrounding image data may be uniquely defined. In other words, the position of each pixel of the image can be set using position coordinates in the coordinate system of the virtual space.

At this time, the image data generation module 40 can align the bow direction in the virtual space with the bow direction in the surrounding image data, based on the heading measured by the heading measurement module 25. Accordingly, the coordinates of each pixel of the image based on the surrounding image data may be set with high accuracy in the coordinate system of the virtual space.

In addition, the image data generation module 40 can switch between the surrounding image data and the forward monitoring image data and output the image data to the combining module 50. Each pixel of the image of the forward monitoring image data can also be set using position coordinates in the coordinate system of the virtual space. The coordinates of each pixel of the image based on the forward monitoring image data may also be set with high accuracy in the coordinate system of the virtual space, based on the heading measured by the heading measurement module 25, as with the surrounding image data.

The designation module 21 may be, for example, composed of a pointer or the like displayed on a display device which is not shown. On the display device, together with the pointer, the aforementioned surrounding image data or forward monitoring image data, as well as AR data described later, may be displayed. The designation module 21 may receive pixel designation by a specific position on the image displayed on the display device being selected with the pointer through an external input operation using a mouse or the like, thereby setting a designated position on the image. The designation module 21 may output the designated position (pixel) on the image to the coordinate calculation module 31.

The coordinate calculation module 31 may calculate the coordinates of the designated position in the virtual space. Since the relationship between each pixel of the image and the coordinate system of the virtual space may be preset as described above, the coordinate calculation module 31 can calculate the coordinates of the designated position in the virtual space from the designated position (pixel) on the image. The coordinate calculation module 31 may output the position coordinates in the virtual space of the designated position to the distance calculation module 32.

The outer shape of the hull 90 in the virtual space may be stored in the distance calculation module 32. The distance calculation module 32 may calculate the shortest distance between the position coordinates in the virtual space of the designated position and the outer shape of the hull. The distance calculation module 32 may output the shortest distance to the AR data generation module 33.

The AR data generation module 33 may generate AR data including text data of the shortest distance, marker data representing the designated position, etc. The AR data generation module 33 can include other auxiliary graphics, such as grid image data described later, in the AR data.

Furthermore, the AR data generation module 33 can include various kinds of navigation assistance information acquired by AIS or the like as described above, in the AR data.

The AR data generation module 33 may output the AR data to the combining module 50.

When the surrounding image data is input, the combining module 50 may combine the surrounding image data and the AR data to generate AR-added image data. When the forward monitoring image data is input, the forward monitoring data and the AR data may be combined. At this time, the combining module 50 may combine the surrounding image data and the AR data, based on the reference point in the virtual space. The combining module 50 may output the composite image data to the display device (not shown) or the like.

The positioning module 22, the movement vector setting module 34, and the correction module 35 may be used, for example, to update or correct the coordinates of the designated position when the hull 90 is moving. Additionally, the position measured by the positioning module 22 may be used to calculate the position coordinates in the virtual space of a target detected by the target detection module 23.

The positioning module 22 may measure the position and velocity of the hull 90 in the Earth coordinate system, using positioning signals from positioning systems such as GPS via an external positioning antenna as inputs. In addition, the positioning module 22 can also measure the velocity, acceleration, and angular velocity of the hull 90 in the hull coordinate system, using sensor signals from an external inertial sensor as inputs. Furthermore, the positioning module 22 can integrate measurements using positioning signals and measurements using sensor signals to measure position, velocity, etc.

In addition, the positioning module 22 may calculate the actual movement vector from the time at which the designated position was designated to the time to be updated, based on the measured position and velocity, in the Earth coordinate system. The positioning module 22 may calculate the actual movement vector in the hull coordinate system, and convert the actual movement vector into the actual movement vector in the Earth coordinate system, based on the heading.

The movement vector setting module 34 may calculate the inverse vector of the actual movement vector and set the calculated inverse vector as a virtual movement vector. Since the Earth coordinate system and the coordinate system of the virtual space may coincide, a virtual movement vector representing the movement of the designated position on the virtual space can be set by the inverse vector of the actual movement vector. The movement vector setting module 34 may output the virtual movement vector to the correction module 35.

The correction module 35 may correct the coordinates of the designated position in the virtual space using the virtual movement vector. The correction module 35 may output the virtual movement vector to the coordinate calculation module 31, and the coordinate calculation module 31 may output the coordinates of the corrected designated position to the distance calculation module 32.

The target detection module 23 and the target identification module 24 may be used, for example, when setting the position of the detected target as a designated position, unlike when a user designates a designated position.

The target detection module 23 may be composed of a radar, a LiDAR, or the like. The target detection module 23 may detect a target around the hull 90 and output the position of the detected target.

The target identification module 24 may identify the type of detected target. The target identification module 24 may output the identification result and position of the detected target to the designation module 21.

The designation module 21 may set the position of the detected target as a designated position. At this time, the position coordinates of the designated position may be set in the hull coordinate system. The coordinate calculation module 31 may calculate the position coordinates in the virtual space of the designated position (specific position) using the position coordinates of the hull 90 in the Earth coordinate system measured by the positioning module 22 and the designated position in the hull coordinate system (corresponding to the specific position) input from the designation module 21. The coordinate calculation module 31 may output the calculated position coordinates in the virtual space of the designated position (specific position) to the distance calculation module 32.

The heading measurement module 25 may measure the heading of the hull 90 (for example, the bow heading) using output signals from an external heading sensor as inputs.

The attitude measurement module 26 may measure the attitude of the hull 90 using output signals from an external attitude sensor as inputs. The attitude measurement module 26 may be used for calculating position coordinates in the coordinate calculation module 31 and for performing motion correction when combining the surrounding image data and the AR data in the combining module 50, when the hull 90 is in motion.

For example, the coordinate calculation module 31 may correct the position coordinates in the virtual space of the designated position (pixel) on the image based on the surrounding image data, using the attitude measured by the attitude measurement module 36.

In addition, the combining module 50 may correct the AR-added image data as if the hull 90 is in motion, using the attitude measured by the attitude measurement module 36.

Using the above configuration as appropriate, the navigation assistance device 10 may perform various processes, for example, as described below.

### Generation of Surrounding Image Data

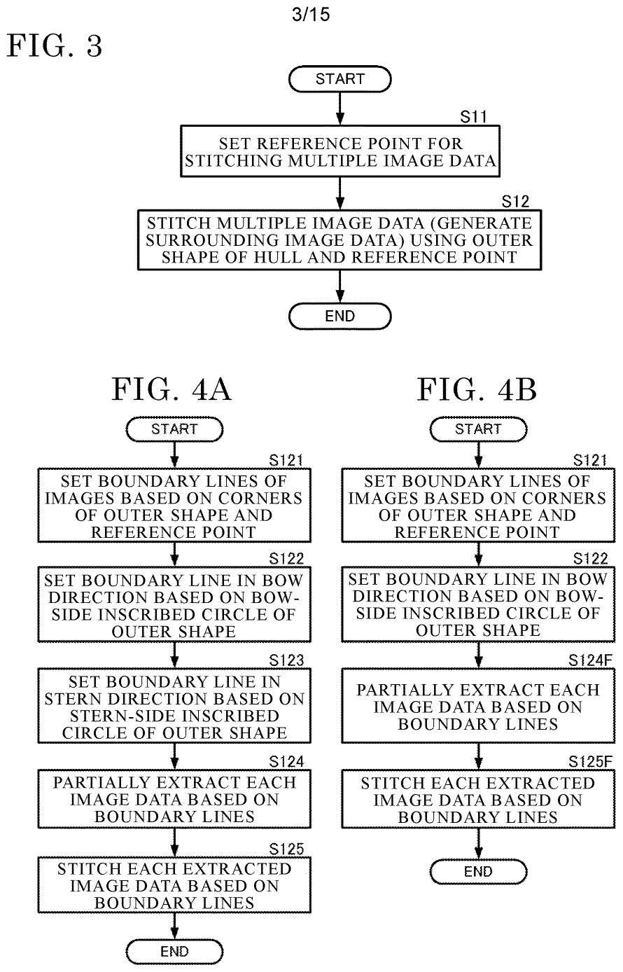

FIG. 3 is a flowchart showing an example of a method for generating surrounding image data. FIG. 4A and FIG. 4B are flowcharts showing specific examples of stitching image data. FIG. 4A shows the case of stitching image data of the bow, the stern, the port side, and the starboard side, and FIG. 4B shows the case of stitching image data of the bow, the port side, and the starboard side.

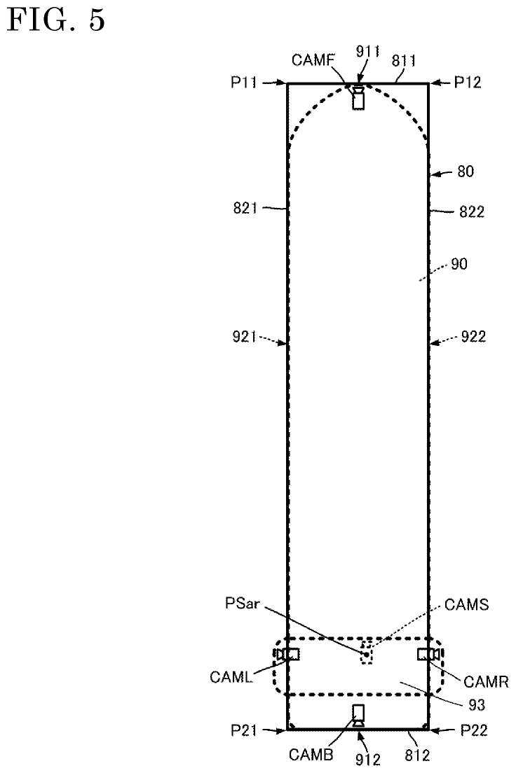

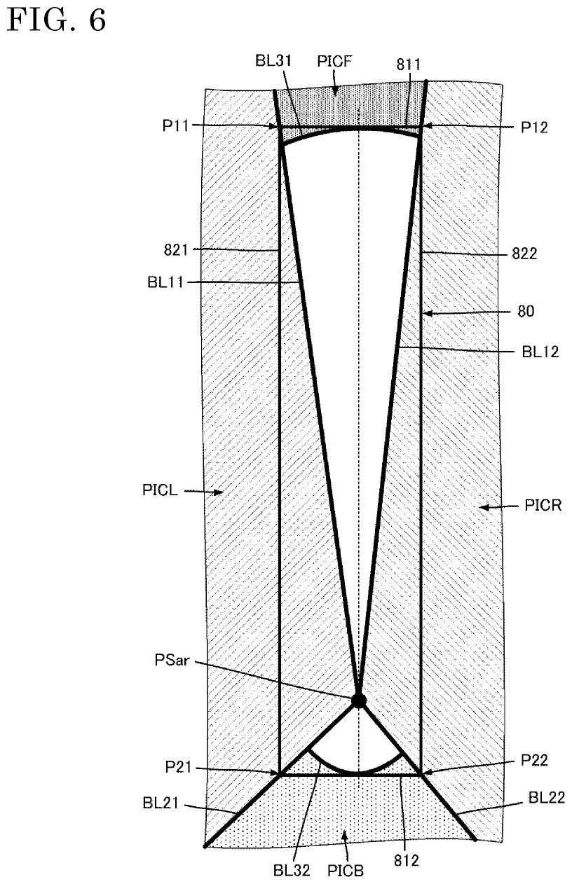

FIG. 5 is a diagram showing an example of setting the outer shape of the hull used for stitching image data. FIG. 6 is a diagram showing an example of setting a boundary for stitching image data.

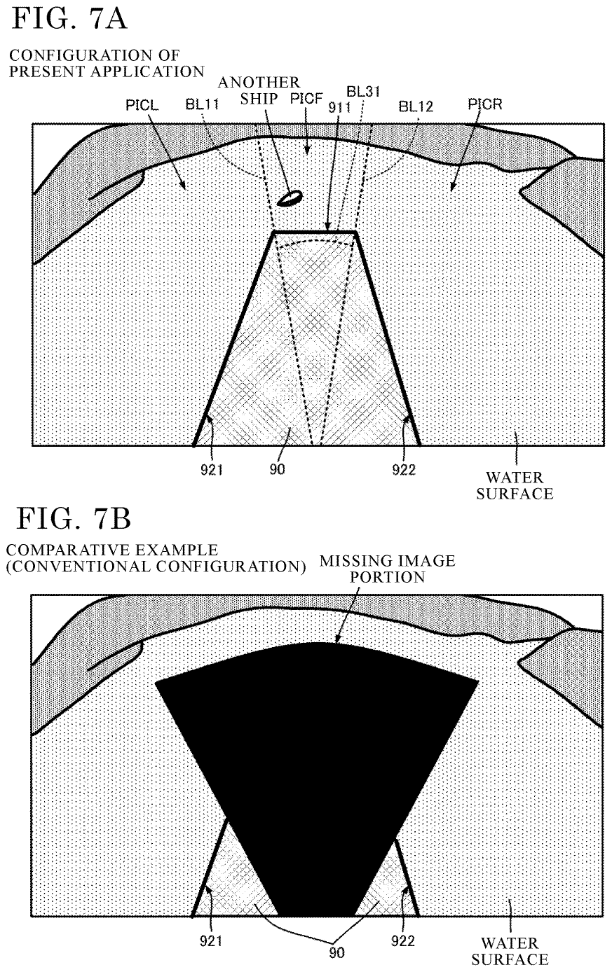

FIG. 7A is a diagram showing an example of a surrounding image according to the configuration of the present application, and FIG. 7B is a diagram showing an example of a surrounding image (comparative surrounding image) according to a comparative example (conventional configuration). In FIG. 7A and FIG. 7B, the illustration of an image on the stern side is omitted, but the image configuration on the stern side is the same as that on the bow side.

Hereinafter, with reference to FIG. 3, FIG. 4A, FIG. 5, and FIG. 6, the case of stitching the image data of the bow, the stern, the port side, and the starboard side will be described as an example.

The bow image data PICF, the port side image data PICL, the starboard side image data PICR, and the stern image data PICB may be input to the image data generation module 40.

The bow image data PICF may be image data captured by the bow camera CAMF and may be data representing an image including the water surface in the bow direction (bow 911 side) of the hull 90. The bow image data PICF may include images of the bow 911, the port side 921, and the starboard side 922 of the hull 90.

The port side image data PICL may be image data captured by the port side camera CAML and may be data representing an image including the water surface in the port side direction (port side 921 side) of the hull 90. The port side image data PICL may include images of the port side 921, the bow 911, and the stern 912 of the hull 90.

The starboard side image data PICR may be image data captured by the starboard side camera CAMR and may be data representing an image including the water surface in the starboard side direction (starboard side 922 side) of the hull 90. The starboard side image data PICR may include images of the starboard side 922, the bow 911, and the stern 912 of the hull 90.

The stern image data PICB may be image data captured by the stern camera CAMB and may be data representing an image including the water surface in the stern direction (stern 912 side) of the hull 90. The stern image data PICB may include images of the stern 912, the port side 921, and the starboard side 922 of the hull 90.

The reference point setting module 100 may set a reference point PSar (see FIG. 5) where the bow image data PICF, the port side image data PICL, the starboard side image data PICR, and the stern image data PICB are stitched. The reference point setting module 100 may set the position coordinates of the virtual camera, that is, reference position coordinates in the virtual space (the position coordinates of the origin), as the reference point PSar (S11).

The image data generation module 40 may stitch the bow image data PICF, the port side image data PICL, the starboard side image data PICR, and the stern image data PICB, using an outer shape 80 of the hull 90 (see FIG. 5) and the reference point PSar, to generate surrounding image data (S12).

More specifically, the image data may be stitched as follows.

The outer shape 80 of the hull 90 may be stored in the image data generation module 40, using position coordinates in the virtual space.

Specifically, the outer shape 80 of the hull 90 may be configured by a port side line 821, a starboard side line 822, a bow line 811, and a stern line 812. The port side line 821 may be a straight line (line segment) that extends along the port side 921 of the hull 90 and overlaps the port side 921 in a plan view of the hull 90. The starboard side line 822 may be a straight line (line segment) that extends along the starboard side 922 of the hull 90 and overlaps the starboard side 922 in a plan view of the hull 90. The bow line 811 may be a straight line (line segment) that passes through the bow 911 and is orthogonal to the port side line 821 and the starboard side line 822 in a plan view of the hull 90. The stern line 812 is a straight line (line segment) that passes through the stern 912 and is orthogonal to the port side line 821 and the starboard side line 822 in a plan view of the hull 90. Therefore, the outer shape 80 of the hull 90 may be a rectangle in which the hull 90 is inscribed in a plan view of the hull 90.

The outer shape 80 may be stored by at least the position coordinates of an intersection point P11 between the port side line 821 and the bow line 811 (see FIG. 5 and FIG. 6), the position coordinates of an intersection point P12 between the starboard side line 822 and the bow line 811 (see FIG. 5 and FIG. 6), the position coordinates of an intersection point P21 between the port side line 821 and the stern line 812 (see FIG. 5 and FIG. 6), and the position coordinates of an intersection point P22 between the starboard side line 822 and the stern line 812 (see FIG. 5 and FIG. 6). That is, the outer shape 80 may be stored by at least the position coordinates of the corners of the rectangle.

The image data generation module 40 may set multiple connection lines that connect the reference point PSar and the respective corners of the rectangle (intersection points P11, P12, P21, and P22). The image data generation module 40 may set multiple connection lines at multiple boundary lines of the image data to be stitched (S121).

More specifically, the image data generation module 40 may set the connection line (straight line) connecting the reference point PSar and the intersection point P11, as a boundary line BL11 (see FIG. 6). The image data generation module 40 may set the connection line (straight line) connecting the reference point PSar and the intersection point P12, as a boundary line BL12 (see FIG. 6). The image data generation module 40 may set the connection line (straight line) connecting the reference point PSar and the intersection point P21, as a boundary line BL21 (see FIG. 6). The image data generation module 40 may set the connection line (straight line) connecting the reference point PSar and the intersection point P22, as a boundary line BL22 (see FIG. 6).

The image data generation module 40 may set a boundary line in the bow direction, based on a bow-side inscribed circle of the outer shape (S122).

More specifically, the image data generation module 40 may calculate a circle (bow-side inscribed circle) that touches the bow line 811, using the reference point PSar as a center. The image data generation module 40 may detect the intersection points between the boundary lines BL11 and BL12 and the bow-side inscribed circle. The image data generation module 40 may extract an arc connecting the boundary line BL11 and the boundary line BL12 on the bow 911 side in the bow-side inscribed circle, and set the arc as a boundary line BL31 in the bow direction.

The image data generation module 40 may set a boundary line in the stern direction, based on a stern-side inscribed circle of the outer shape (S123).

More specifically, the image data generation module 40 may calculate a circle (stern-side inscribed circle) that touches the stern line 812, using the reference point PSar as a center. The image data generation module 40 may detect the intersection points between the boundary lines BL21 and BL22 and the stern-side inscribed circle. The image data generation module 40 may extract an arc connecting the boundary line BL21 and the boundary line BL22 on the stern 912 side in the stern-side inscribed circle, and set the arc as a boundary line BL32 in the stern direction.

The image data generation module 40 may partially extract each image data, based on the boundary lines (S124).

More specifically, the image data generation module 40 may partially extract the region between the boundary line BL11 and the boundary line BL21 from the port side image data PICL. The image data generation module 40 may partially extract the region between the boundary line BL12 and the boundary line BL22 from the starboard side image data PICR.

The image data generation module 40 may partially extract the region outside the boundary line BL31 (on the side farther from the hull 90 with the bow 911 as a reference) between the boundary line BL11 and the boundary line BL12 from the bow image data PICF. The image data generation module 40 may partially extract the region outside the boundary line BL32 (on the side farther from the hull 90 with the stern 912 as a reference) between the boundary line BL21 and the boundary line BL22 from the stern image data PICB.

The image data generation module 40 may stitch each extracted image data, based on the boundary lines, to generate surrounding image data (S125).

More specifically, the image data generation module 40 may stitch the bow image data PICF and the port side image data PICL, based on the boundary line BL11. The image data generation module 40 may stitch the bow image data PICF and the starboard side image data PICR, based on the boundary line BL12. The image data generation module 40 may stitch the stern image data PICB and the port side image data PICL, based on the boundary line BL21. The image data generation module 40 may stitch the stern image data PICB and the starboard side image data PICR, based on the boundary line BL22.

By such processing, the image data generation module 40 can generate surrounding image data showing the water surface around the entire periphery of the hull 90, as shown in FIG. 7A. Therefore, the navigation assistance device 10 can reduce missing portions in the surrounding image data.

On the other hand, in the comparative example (conventional configuration), as shown in FIG. 7B, a missing image portion occurs at the bow 911 of the hull 90.

For example, in a ship having a high draft, placing the bow camera CAMF on the deck 900 makes it difficult to capture an image of the water surface near the bow 911.

However, the navigation assistance device 10 may perform stitching as described above, using the image, including the bow 911, captured by the port side camera CAML and the starboard side camera CAMR. Accordingly, the navigation assistance device 10 can generate surrounding image data that shows the water surface near the bow 911. At this time, as shown in FIG. 7A, the surrounding image data may include images of the bow 911, the port side 921, and the starboard side 922. Accordingly, the surrounding image data may include images of the water surface, the bow 911, the port side 921, and the starboard side 922. The user can clearly understand that the image based on the surrounding image data is a surrounding image near the hull 90. For example, the user can easily recognize the situation near the hull 90 (for example, another nearby ship) as shown in FIG. 7A.

Also, in the case of a large cargo ship or the like in which the overall length of the hull 90 is long and the bridge 93 is close to the stern, the portion between the bow 911 and the bridge 93 on the hull 90 does not exist as an image. However, the image data generation module 40 may perform stitching using the aforementioned boundary line BL31. Accordingly, the navigation assistance device 10 can generate surrounding image data including an image of the portion between the bow 911 and the bridge 93 on the hull 90. Therefore, the navigation assistance device 10 can provide the user with a surrounding image that does not cause any discomfort.

In the navigation assistance device 10, the position of the virtual camera (the reference point in the virtual space and the reference point for stitching the image data) may be set based on the positions of the bow camera CAMF, the port side camera CAML, the starboard side camera CAMR, and the stern camera CAMB in a plan view of the hull 90. Accordingly, the combining module 50 can suppress the displacement in combining position between the surrounding image data and the AR data in the composite image data.

In addition, the port side camera CAML and the starboard side camera CAMR may be positioned vertically higher than the bow camera CAMF and the stern camera CAMB. Accordingly, the port side camera CAML and the starboard side camera CAMR can more reliably capture images of the water surface near the bow 911 and the water surface near the stern 912. Therefore, the image data generation module 40 can generate surrounding image data that more reliably includes the water surface near the bow 911 and the water surface near the stern 912.

In addition, the port side camera CAML, the starboard side camera CAMR, the bow camera CAMF, and the stern camera CAMB may be fisheye cameras. The horizontal field of view of each camera can be widened, thereby more reliably eliminating blind spots around the hull 90.

In addition, the image data generation module 40 may perform motion correction on the surrounding image data, based on the attitude measured by the attitude measurement module 26. Accordingly, even if the hull 90 is in motion, the image data generation module 40 can correct the surrounding image such that the surrounding image does not appear to be in motion. In other words, in reality, the hull 90 is in motion, and the Earth (surroundings of the hull 90) is not in motion. Since each camera may be installed on the hull 90, when the hull 90 is in motion, the surrounding image data may also be in motion. Therefore, the image data generation module 40 can generate surrounding image data without motion, by correcting the surrounding image data using the attitude of the hull 90.

### Calculation of Shortest Distance between Designated Position (Specific Position) and Hull

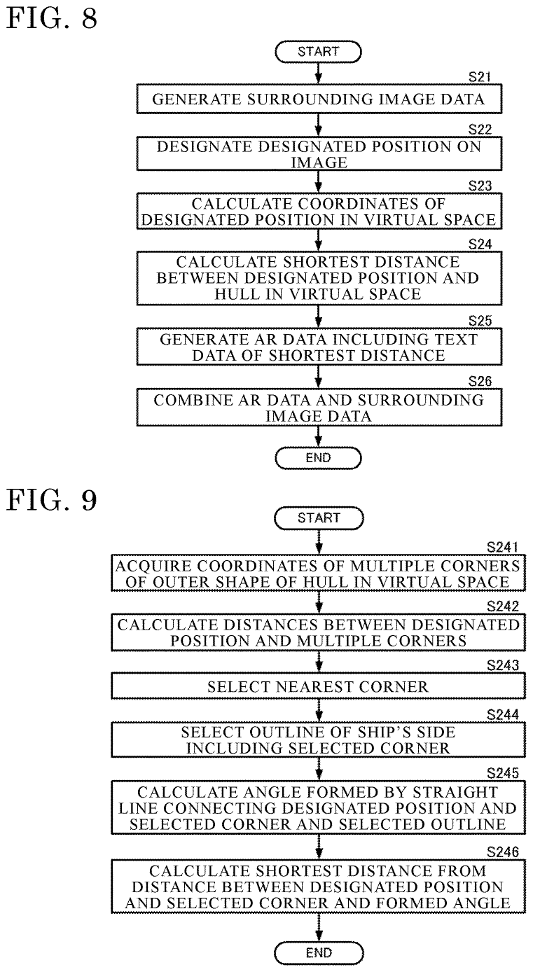

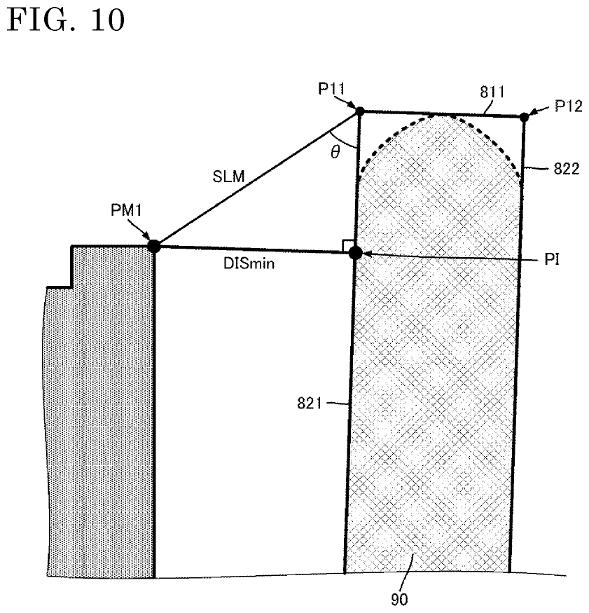

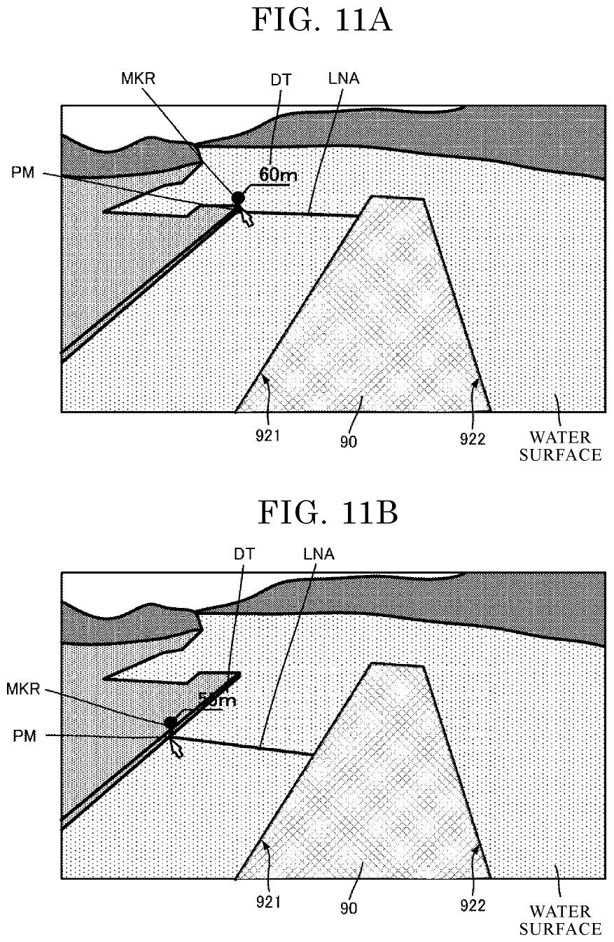

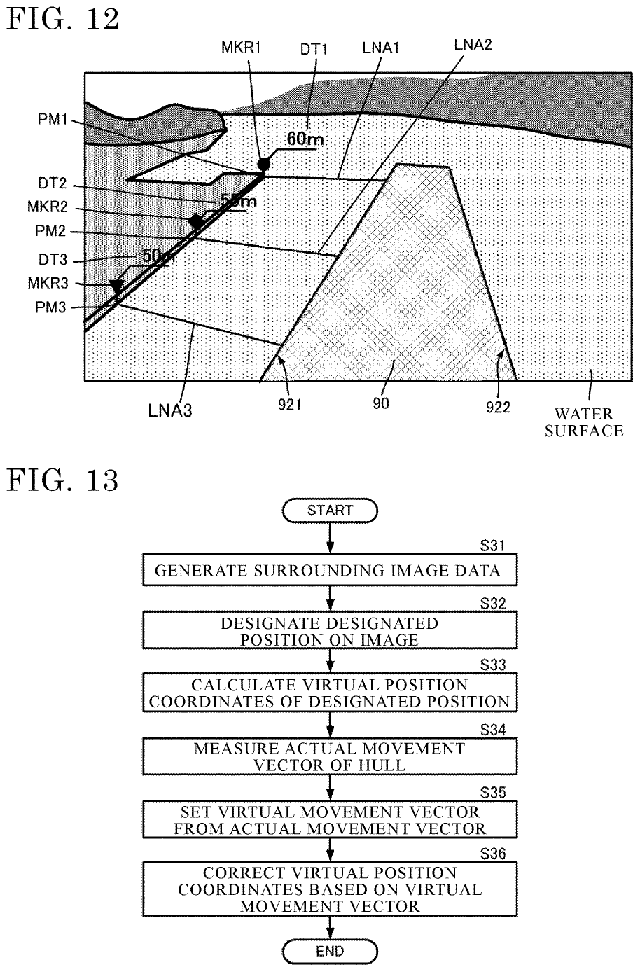

FIG. 8 is a flowchart showing an example of a method for calculating the shortest distance between a designated position and the hull and a method for displaying the shortest distance. FIG. 9 is a flowchart showing an example of a specific method for calculating the shortest distance between the designated position and the hull. FIG. 10 is a diagram illustrating the concept of calculating the shortest distance. FIG. 11A and FIG. 11B are diagrams showing examples of an image using composite image data including the shortest distance. In FIG. 11A and FIG. 11B, designated positions are different. FIG. 12 is a diagram showing an example of an image based on composite image data when multiple designated positions are designated.

The image data generation module 40 may generate surrounding image data that shows the surroundings of the hull 90 as described above (S21). The combining module 50 may combine the surrounding image data and the AR data to generate composite image data.

The designation module 21 may designate a designated position PM on the image based on the surrounding image data (see FIG. 11A and FIG. 11B) (S22). For example, the user may operate a pointer placed on the image and perform a click or the like at the designated position PM. The designation module 21 may designate the designated position PM on the image in units of pixels by detecting this click position. The designation module 21 may output the designated position PM to the coordinate calculation module 31.

The coordinate calculation module 31 may calculate the coordinates of the designated position PM in the virtual space corresponding to the pixel of the designated position PM on the image (S23). The coordinate calculation module 31 may output the coordinates of the designated position PM in the virtual space to the distance calculation module 32.

The distance calculation module 32 may calculate a shortest distance DISmin between the designated position PM in the virtual space and the hull 90 (S24). The distance calculation module 32 may output the shortest distance DISmin to the AR data generation module 33.

More specifically, the distance calculation module 32 may calculate the shortest distance DISmin as follows. At this time, the distance calculation module 32 may calculate the shortest distance DISmin in the coordinate system of the virtual space.

The distance calculation module 32 may acquire the coordinates of the multiple corners (intersection points P11, P12, P21, and P22) of the outer shape of the hull 90 (corresponding to the hull region coordinates) (S241).

The distance calculation module 32 may calculate the distances between the designated position PM and the multiple corners (intersection points P11, P12, P21, and P22) (S242). At this time, the distance calculation module 32 may project the designated position PM and the multiple corners onto a horizontal plane (a two-dimensional plane with the fore-aft direction and the port-starboard direction as axes) and calculate the distances therebetween.

The distance calculation module 32 may compare each distance and select the nearest corner (intersection point) (S243). For example, in the case of FIG. 10, the designated position PM may be on the port side 921 side of the hull 90, closer to the bow 911 than to the stern 912. In this case, the distance calculation module 32 may select the intersection point P11.

The distance calculation module 32 may select an outline of the ship's side that includes the selected corner (intersection point) (S244). For example, in the case of FIG. 10, the distance calculation module 32 may select the port side line 821 passing through the intersection point P11.

The distance calculation module 32 may calculate an angle θ formed by a straight line connecting the designated position PM and the selected corner (intersection point) and the selected outline line (S245), and, for example, in the case of FIG. 10, the distance calculation module 32 may calculate an angle θ formed by a straight line connecting the designated position PM and the intersection point P11 and the port side line 821.

The distance calculation module 32 may calculate the shortest distance DISmin, using known geometric calculations, from a distance SLM between the designated position PM and the selected corner (intersection point) and the formed angle θ (S246). A shortest point PI on the hull 90, where the shortest distance DISmin is achieved, corresponds to the foot of a perpendicular dropped from the designated position PM to the hull 90 (see FIG. 10). Therefore, the distance calculation module 32 can calculate the shortest distance DISmin by known geometric calculations using trigonometric functions and the like.

If a function for the outline of a ship's side is known, the distance calculation module 32 can also calculate the shortest distance DISmin using a formula for the distance between a point and a straight line.

Also, the calculation of the shortest distance DISmin may be performed in the Earth coordinate system. However, there may be a possibility that factors causing calculation errors, such as an increase in the number of coordinate transformations, may increase. Therefore, it is preferable to calculate the shortest distance DISmin in the coordinate system of the virtual space.

The AR data generation module 33 may generate AR data including text data of the shortest distance DISmin (S25).

More specifically, the AR data generation module 33 may generate text data DT (see FIG. 11) of the shortest distance DISmin. The AR data generation module 33 may place marker data MKR (see FIG. 11) indicating the designated position PM, at the position of the designated position PM. The AR data generation module 33 may place the text data DT of the shortest distance DISmin near the marker data MKR.

Placing the marker data MKR allows the user to easily recognize the designated position PM. Additionally, placing the text data DT near the marker data MKR allows the user to easily recognize the shortest distance from the hull 90 to the designated position PM. In particular, since the shortest distance to the port side or the starboard side is easily recognized, the shortest distance between a quay and the hull 90 can be easily recognized during berthing or departure.

The AR data generation module 33 may output the AR data to the combining module 50. The combining module 50 may combine the AR data and the surrounding image data to generate composite image data. Accordingly, as shown in FIG. 11A and FIG. 11B, the navigation assistance device 10 can provide the user with an image in which the shortest distance DISmin between the designated position PM and the hull 90 is displayed. The navigation assistance device 10 can measure the distance between any position on the image and the hull through an intuitive operation and provide the distance to the user.

As shown in FIG. 11A and FIG. 11B, an auxiliary line LNA that visually provides the shortest distance DISmin may be added to the AR data. This allows the user to easily recognize the position closest to the designated position PM on the hull 90.

Also, as shown in FIG. 11A and FIG. 11B, the designated position PM is movable. The movement of the designated position PM is possible, for example, by clipping and moving the designated position PM (marker data MKR) on the image. The distance calculation module 32 may recalculate and update the shortest distance DISmin in accordance with the movement of the designated position PM.

In addition, the navigation assistance device 10 can also cancel the designated position PM by performing a click thereon. For example, the navigation assistance device 10 can cancel the designated position PM by detecting a second click on the designated position PM.

Also, as shown in FIG. 12, the navigation assistance device 10 can designate multiple designated positions PM1, PM2, and PM3, and calculate shortest distances DISmin1, DISmin2, and DISmin3 for the respective positions. In this case, the designation module 21 may designate the multiple designated positions PM1, PM2, and PM3. For example, by clicking on multiple locations on the image, the multiple designated positions PM1, PM2, and PM3 can be designated.

The distance calculation module 32 may calculate the shortest distances DISmin1, DISmin2, and DISmin3 for the multiple designated positions PM1, PM2, and PM3, respectively, using the aforementioned method.

The AR data generation module 33 may generate text data DT1, DT2, and DT3 of the shortest distances for the multiple designated positions PM1, PM2, and PM3, respectively.

The AR data generation module 33 may place marker data MKR1 indicating the designated position PM1, at the position of the designated position PM1, place the text data DT1 of the shortest distance DISmin1 near the marker data MKR1, and place an auxiliary line LNA1. The AR data generation module 33 may place marker data MKR2 indicating the designated position PM2, at the position of the designated position PM2, place the text data DT2 of the shortest distance DISmin2 near the marker data MKR2, and place an auxiliary line LNA2. The AR data generation module 33 may place marker data MKR3 indicating the designated position PM3, at the position of the designated position PM3, place the text data DT3 of the shortest distance DISmin3 near the marker data MKR3, and place an auxiliary line LNA3.

With such a configuration, the navigation assistance device 10 can provide the user with the shortest distances to multiple designated positions simultaneously in a single composite image.

The navigation assistance device 10 may be configured to allow the designated position PM to be designated only when the distance from the hull 90 to the designated position PM is equal to or less than a threshold distance. In the surrounding image, the length corresponding to one pixel increases as the distance from the hull 90 increases. Therefore, the navigation assistance device 10 can reduce a designation error of the designated position PM and a calculation error of the shortest distance DISmin by limiting the range of the designated position PM to a range that is not too far from the hull 90.

In the aforementioned case, the user designates the designated position PM, but a designated position can also be designated using the position of a detected target.

In this case, the target detection module 23 may detect a target around the hull 90 and the actual position (position in the Earth coordinate system) of the target. The designation module 21 may set the actual position of the target as a designated position PM. The distance calculation module 32 may calculate the shortest distance DISmin using the designated position PM.

The navigation assistance device 10 can designate and cancel the designated position PM, based on the distance from the hull 90 to the target.

In this case, the distance calculation module 32 may calculate the target distance from the hull 90 to the target, based on the actual position of the hull 90 acquired from the positioning module 22 and the actual position of the target. If the target distance becomes equal to or less than a predetermined target distance, the designation module 21 may designate the designated position PM, based on the actual position of the target. On the other hand, if the target distance becomes greater than the predetermined target distance, the designation module 21 may cancel the designation of the designated position PM based on the actual position of the target.

The navigation assistance device 10 can also designate the designated position PM in accordance with the type of the target.

In this case, the target identification module 24 may identify the type of the target detected by the target detection module 23. If the type of the target is any of a quay, another ship, or a buoy, the designation module 21 may set the designated position PM. The type of targets that can be set as the designated position PM can be set by the user. Accordingly, the navigation assistance device 10 can provide the shortest distance DISmin to a target desired by the user.

The navigation assistance device 10 may update the calculation of the shortest distance DISmin in accordance with the movement of the hull 90.

In this case, the coordinate calculation module 31 may acquire the movement result of the hull 90 and correct the designated position PM. This correction method will be described in the later section [Correction of Designated Position]. The distance calculation module 32 may update the calculation of the shortest distance DISmin, based on the designated position PM corrected in accordance with the movement of the hull 90.

Also, in this case, the updated shortest distance DISmin may be input to the designation module 21. If the shortest distance DISmin becomes equal to or greater than a predetermined actual distance, the designation module 21 may delete the designated position, and the distance calculation module 32 may stop calculating the shortest distance DISmin. In this case, if the shortest distance DISmin becomes equal to or greater than the predetermined actual distance, the AR data generation module 33 may stop generating the text data DT of the shortest distance DISmin.

Accordingly, the navigation assistance device 10 can suppress provision of the shortest distance DISmin having a large error to the user.

### Correction of Designated Position

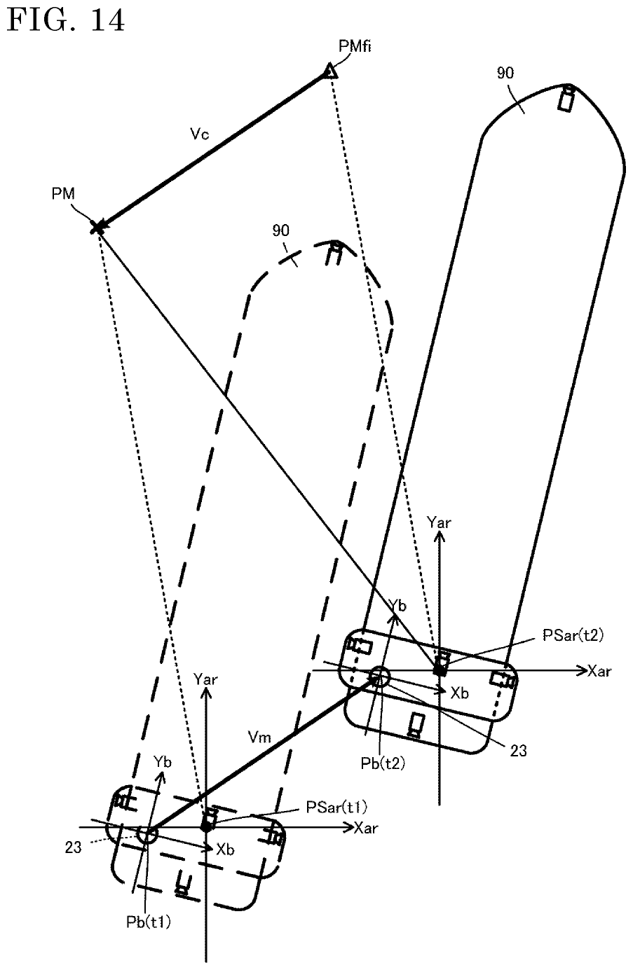

FIG. 13 is a flowchart showing an example of a method for correcting a designated position. FIG. 14 is a diagram illustrating the concept of correcting a designated position. In FIG. 14, Xar and Yar indicate the coordinate axes of the coordinate system of the virtual space, and Xb and Yb indicate the coordinate axes of the hull coordinate system.

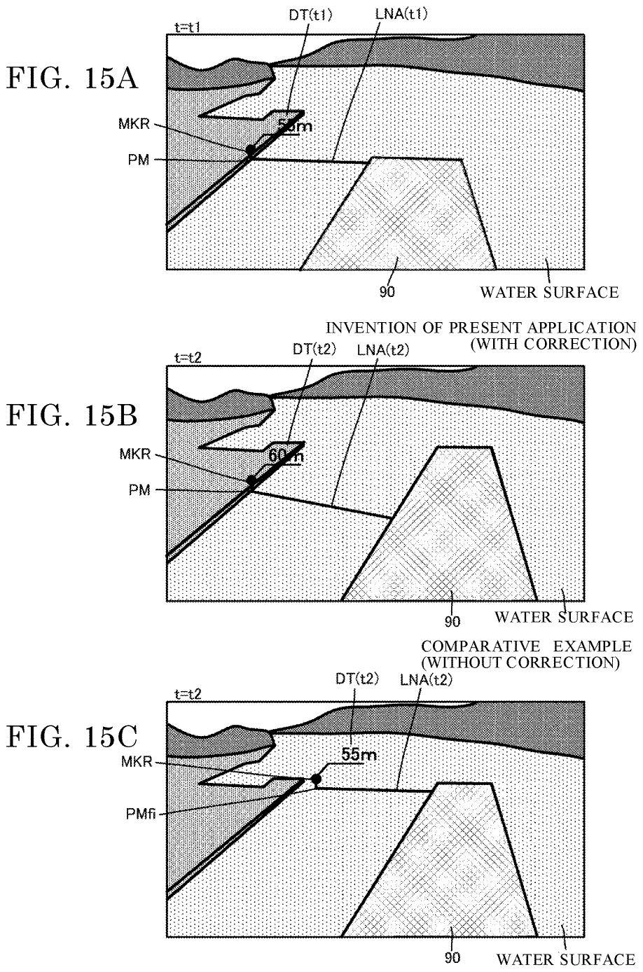

FIG. 15A is a composite image before movement of the hull, FIG. 15B is a composite image after movement of the hull when the configuration of the present application is used, and FIG. 15C is a composite image after movement of the hull when the configuration of the present application is not used (in the case of the conventional configuration).

The image data generation module 40 may generate surrounding image data of the hull 90 using the aforementioned method (S31). The designation module 21 may designate a designated position PM on the image based on the surrounding image data using the aforementioned method (S32). The coordinate calculation module 31 may calculate the position coordinates in the virtual space corresponding to the designated position on the image using the aforementioned method (S33).

The positioning module 22 may measure an actual movement vector Vm of the hull 90 (see FIG. 14) in the Earth coordinate system using the aforementioned method (S34). The positioning module 22 may measure the actual movement vector Vm in the hull coordinate system.

The movement vector setting module 34 may set a virtual movement vector in the virtual space from the actual movement vector (S35). More specifically, if the actual movement vector is measured in the Earth coordinate system, the movement vector setting module 34 may calculate the inverse vector of the actual movement vector and set the calculated inverse vector as a virtual movement vector Vc (see FIG. 14). If the actual movement vector is measured in the hull coordinate system, the movement vector setting module 34 may convert the actual movement vector in the hull coordinate system into the actual movement vector in the Earth coordinate system and calculate the inverse vector of the converted actual movement vector, thereby setting the virtual movement vector Vc.

The correction module 35 may correct the position coordinates (designated coordinates) of the designated position PM in the virtual space, based on the virtual movement vector Vc (S36). In other words, the correction module 35 may correct a heading vector from the reference point PSar of the surrounding image data in the virtual space to the designated position PM, using the virtual movement vector VC, thereby correcting the designated position PM.

Since the designated position PM may be a position at which a pixel is designated on the image, even if the hull 90 moves, the position relative to the reference point PSar in the virtual space does not change unless correction is performed. Therefore, due to the movement of the hull 90, a false designated position PMfi shown in FIG. 14 may be obtained.

However, the navigation assistance device 10 can correct the false designated position PMfi, using the virtual movement vector Vc, as shown in FIG. 14, and continue to set the designated position PM corresponding to the movement of the hull 90.

With such a configuration, the navigation assistance device 10 can change the composite image shown in FIG. 15A to the composite image shown in FIG. 15B in accordance with the movement of the hull 90. In other words, if the hull 90 moves, the navigation assistance device 10 can move the position of the designated position PM on the composite image in accordance with this movement. Therefore, the navigation assistance device 10 can suppress displacement of the position of the marker on the image caused by the movement of the hull 90.

At this time, the navigation assistance device 10 may recalculate the shortest distance DISmin between the designated position PM due to the movement of the hull 90 and the hull 90, update the shortest distance DISmin, and display the shortest distance DISmin.

On the other hand, as shown in FIG. 15C, if the configuration of the present application is not provided, even if the hull 90 moves, the designated position PMfi on the composite image will be the same as the designated position PM before the movement of the hull 90 (at the time when the designated position PM was designated). Also, the shortest distance DISmin is not updated.

Thus, the navigation assistance device 10 can provide the shortest distance DISmin at each time point with high accuracy while suppressing undesirable changes in the designated position PM on the image caused by the movement of the hull 90.

### Generation of Grid Line Image

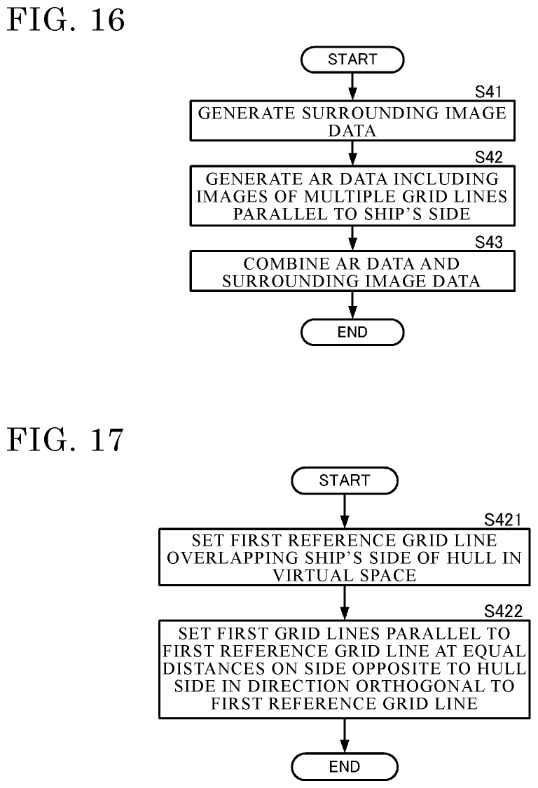

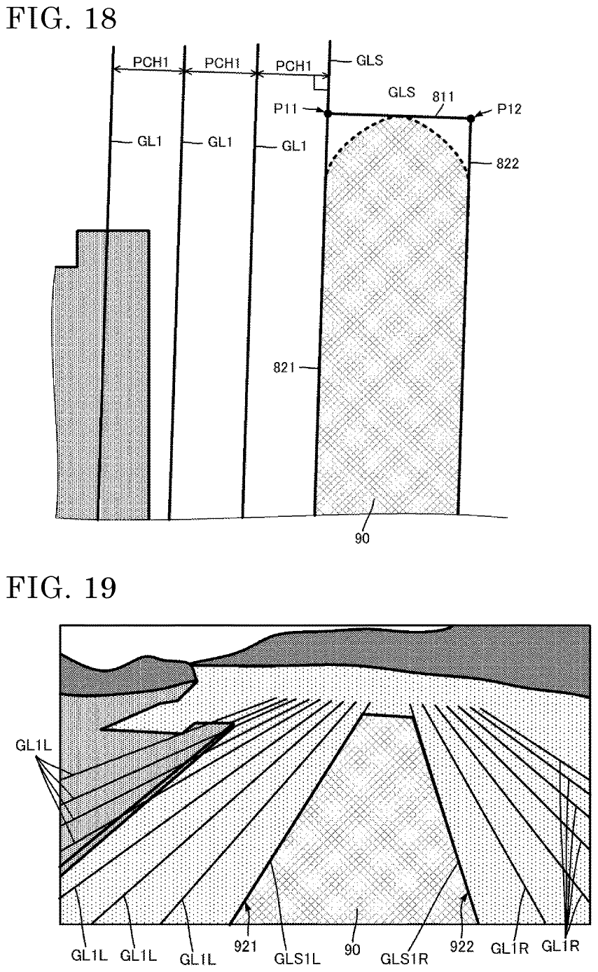

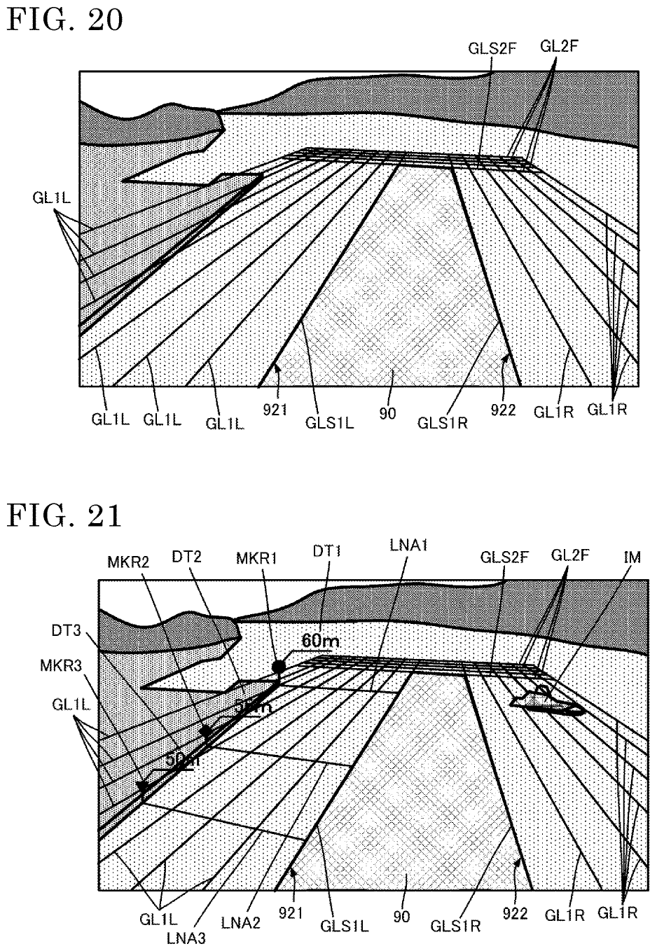

FIG. 16 is a flowchart showing an example of a method for generating a grid line image. FIG. 17 is a flowchart showing an example of a specific method for generating grid lines. FIG. 18 is a diagram illustrating the concept of setting grid lines. FIG. 19 and FIG. 20 are diagrams showing examples of a composite image including grid lines. FIG. 19 shows the case where only grid lines parallel to the ship's side are formed, and FIG. 20 shows the case where grid lines parallel to the ship's side (first grid lines) and grid lines orthogonal to the ship's side (second grid lines) are formed.

The image data generation module 40 may generate surrounding image data of the hull 90 including the ship's sides (port side 921 and starboard side 922) of the hull 90 and the water surface outside the ship's sides, using the aforementioned method (S41).

The AR data generation module 33 may generate AR data including grid image data having multiple first grid lines arranged parallel to the ship's sides (port side 921 and starboard side 922) and spaced apart from each other (S42).

More specifically, for example, in the case of the port side 921 side, multiple first grid lines may be set as shown below. The setting method for the starboard side 922 side is the same as for the port side 921, and thus only the setting method for the port side 921 side will be described.

The AR data generation module 33 may set a first reference grid line GLS that is a straight line overlapping the port side 921 of the hull 90 in the virtual space, as shown in FIG. 18 (S421). In other words, the AR data generation module 33 may set a straight line passing through the intersection point P11 and the intersection point P21 of the rectangle indicating the outer shape of the hull 90, as the first reference grid line GLS.

The AR data generation module 33 may set multiple first grid lines GL1 at equal distances PCH1 on the side opposite to the hull 90 side in a direction orthogonal to the first reference grid line GLS (S422). The multiple first grid lines GL1 may be straight lines parallel to the first reference grid line GLS.

The combining module 50 may combine the AR data and the surrounding image data such that the multiple first grid lines GL1 are arranged with a ship's side (port side 921 or starboard side 922) as a reference, in the region corresponding to the water surface (S43).

With such a configuration, as shown in FIG. 19, the navigation assistance device 10 can provide a composite image in which multiple first grid lines GL1L parallel to the port side 921 are arranged on the port side 921 side of the hull 90 at the same height as the water surface, and multiple first grid lines GL1R parallel to the starboard side 922 are arranged on the starboard side 922 side of the hull 90 at the same height as the water surface. Accordingly, the navigation assistance device 10 can generate an image that makes it easy to visually recognize the distances to a target such as another ship on the water surface and to a quay or the like. Then, the user can intuitively recognize the distances to a target such as another ship on the water surface at the port side 921 and starboard side 922 of the hull 90 and to a quay or the like.

In addition, the navigation assistance device 10 may also display a first reference grid line GLS1L overlapping the port side 921 and a first reference grid line GLS1R overlapping the starboard side 922. This allows the user to easily recognize the position of the port side 921 and the position of the starboard side 922. At this time, for example, the first reference grid line GLS1L and the first reference grid line GLS1R can be displayed in a manner different from the multiple first grid lines GL1L and the multiple first grid lines GL1R. This allows the user to more clearly recognize the position of the port side 921 and the position of the starboard side 922.

The interval PCH1 between the multiple first grid lines GL1 (GL1L, GL1R) can be set by the user. At this time, it is also possible to make the interval between the first grid lines GL1L on the port side 921 side different from the interval between the first grid lines GL1R on the starboard side 922 side.

The interval PCH1 between the multiple first grid lines GL1 can be set based on the ship speed measured by the positioning module 22. For example, the interval PCH1 can be narrowed as the ship speed increases, or the interval PCH1 can be narrowed as the ship speed decreases.

The AR data generation module 33 can set the interval PCH1 between multiple first reference grid lines GLS, based on the actual distance in the Earth coordinate system between a specific position (the designated position PM or the position of a detected target) and a ship's side. In this case, the navigation assistance device 10 may be composed of a designation module or a target detection module 23, and may include a specifying module that identifies a specific position outside the hull 90. The navigation assistance device 10 may calculate the actual distance between the specific position in the Earth coordinate system and the ship's side. Specifically, if the specific position is the position of a target, the target detection module 23 may measure the distance to the target and calculate the actual distance. Meanwhile, if the specific position is the designated position PM, the shortest distance DISmin calculated by the aforementioned method may be used as the actual distance.

The AR data generation module 33 can further set multiple second grid lines GLF2 as shown in FIG. 20. In FIG. 20, only the bow 911 side is shown, but the stern 912 side can also be set similarly. Specifically, the multiple second grid lines GLS2 may be set as follows.

The AR data generation module 33 may set a second reference grid line GLS2F that is a straight line orthogonal to the ship’ side and in contact with the bow 911 in the virtual space. In other words, the AR data generation module 33 may set a straight line passing through the intersection point P11 and the intersection point P12 of the rectangle indicating the outer shape of the hull 90, as the second reference grid line GLS2F.

The AR data generation module 33 may set multiple second grid lines GL2F at equal distances on the side opposite to the hull 90 side in a direction orthogonal to the second reference grid line GLS2F. The multiple second grid lines GL2F may be straight lines parallel to the second reference grid line GLS2F.

The combining module 50 may combine the grid image data and the surrounding image data such that the multiple second grid lines GL2F are arranged forward of the bow 911 of the hull 90 with the bow 911 as a reference, in the region corresponding to the water surface area.

With this configuration, the navigation assistance device 10 can arrange grid lines not only on the port side 921 side and the starboard side 922 side but also on the bow 911 side and the stern 912 side. This allows the user to intuitively recognize the distances to a target such as another ship on the water surface around the entire periphery of the hull 90 and to a quay or the like.

The AR data generation module 33 can make the interval between the multiple first grid lines GL1 and the interval between the multiple second grid lines GL2 either the same or different. Accordingly, the navigation assistance device 10 can set multiple grid lines according to the situation around the hull 90.

### Example of Composite Image Obtained by Combining Above Multiple Processes

FIG. 21 is a diagram showing an example of a composite image. The composite image shown in FIG. 21 may be displayed based on composite image data obtained by combining surrounding image data generated by the aforementioned method, information regarding the shortest distance DISmin, and AR data including multiple grid lines.

Thus, by combining the aforementioned methods, the navigation assistance device 10 can provide an AR composite image corresponding to information desired by the user. At this time, the navigation assistance device 10 can select the information to be displayed as the AR data, generate AR composite image data corresponding to the selection, and provide the AR composite image data to the user.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately,” “about,” and “substantially” as used herein include the recited numbers, and also represent an amount close to the stated amount that still performs a desired function or achieves a desired result. For example, unless otherwise explicitly stated, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

Although the present disclosure may describe certain embodiments with reference to a particular type of mobile platform, the techniques disclosed herein are not limited thereto and may be applied, with appropriate modifications, to various types of mobile platforms operating in different environments, such as marine, aerial, or terrestrial environments, without departing from the spirit of the disclosure. For example, such mobile platforms are not limited to vessels and may include vehicles and aircraft.

As used herein, the terms “vessel,” “watercraft,” “ship,” “boat,” and other related terms used in this specification should be interpreted to include any marine craft capable of navigating on or through water, whether manned or unmanned, unless otherwise noted.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A navigation assistance device comprising processing circuitry configured to:
generate surrounding image data of a hull including a ship's side of the hull and a water surface outside the ship's side;
generate augmented reality (AR) data including grid image data having multiple first grid lines arranged parallel to the ship's side and spaced apart from each other; and
combine the AR data and the surrounding image data such that the multiple first grid lines are arranged with the ship's side as a reference in a region corresponding to the water surface.

2. The navigation assistance device according to claim 1, wherein the processing circuitry spaces the multiple first grid lines at equal intervals.

3. The navigation assistance device according to claim 1, wherein
the processing circuitry is further configured to detect an actual ship speed of the hull in an Earth coordinate system, and
the processing circuitry sets an interval between the multiple first grid lines, based on the actual ship speed.

4. The navigation assistance device according to claim 1, wherein
the processing circuitry is further configured to:
specify a specific position outside the hull; and
calculate an actual distance between the specific position in an Earth coordinate system and the ship's side, and
the processing circuitry sets an interval between the multiple first grid lines, based on the actual distance.

5. The navigation assistance device according to claim 1, wherein
the processing circuitry generates the grid image data to have the multiple first grid lines and multiple second grid lines arranged orthogonal to the ship's side and spaced apart from each other, and
the processing circuitry combines the grid image data and the surrounding image data such that the multiple second grid lines are arranged forward of a bow of the hull with the bow as a reference, in the region corresponding to the water surface.

6. The navigation assistance device according to claim 2, wherein
the processing circuitry generates the grid image data to have the multiple first grid lines and multiple second grid lines arranged orthogonal to the ship's side and spaced apart from each other, and
the processing circuitry combines the grid image data and the surrounding image data such that the multiple second grid lines are arranged forward of a bow of the hull with the bow as a reference, in the region corresponding to the water surface.

7. The navigation assistance device according to claim 3, wherein
the processing circuitry generates the grid image data to have the multiple first grid lines and multiple second grid lines arranged orthogonal to the ship's side and spaced apart from each other, and
the processing circuitry combines the grid image data and the surrounding image data such that the multiple second grid lines are arranged forward of a bow of the hull with the bow as a reference, in the region corresponding to the water surface.

8. The navigation assistance device according to claim 4, wherein
the processing circuitry generates the grid image data to have the multiple first grid lines and multiple second grid lines arranged orthogonal to the ship's side and spaced apart from each other, and
the processing circuitry combines the grid image data and the surrounding image data such that the multiple second grid lines are arranged forward of a bow of the hull with the bow as a reference, in the region corresponding to the water surface.

9. The navigation assistance device according to claim 5, wherein the processing circuitry combines the grid image data and the surrounding image data such that the multiple second grid lines are arranged rearward of a stern of the hull with the stern as a reference, in the region corresponding to the water surface.

10. The navigation assistance device according to claim 6, wherein the processing circuitry combines the grid image data and the surrounding image data such that the multiple second grid lines are arranged rearward of a stern of the hull with the stern as a reference, in the region corresponding to the water surface.

11. The navigation assistance device according to claim 7, wherein the processing circuitry combines the grid image data and the surrounding image data such that the multiple second grid lines are arranged rearward of a stern of the hull with the stern as a reference, in the region corresponding to the water surface.

12. The navigation assistance device according to claim 8, wherein the processing circuitry combines the grid image data and the surrounding image data such that the multiple second grid lines are arranged rearward of a stern of the hull with the stern as a reference, in the region corresponding to the water surface.

13. The navigation assistance device according to claim 5, wherein the processing circuitry makes an interval between the multiple first grid lines and an interval between the multiple second grid lines the same.

14. The navigation assistance device according to claim 6, wherein the processing circuitry makes the interval between the multiple first grid lines and an interval between the multiple second grid lines the same.

15. The navigation assistance device according to claim 7, wherein the processing circuitry makes the interval between the multiple first grid lines and an interval between the multiple second grid lines the same.

16. The navigation assistance device according to claim 8, wherein the processing circuitry makes the interval between the multiple first grid lines and an interval between the multiple second grid lines the same.

17. The navigation assistance device according to claim 5, wherein the processing circuitry makes an interval between the multiple first grid lines different from an interval between the multiple second grid lines.

18. A navigation assistance data generation method, comprising:
generating surrounding image data of a hull including a ship's side of the hull and a water surface outside the ship's side;
generating augmented reality (AR) data including grid image data having multiple first grid lines arranged parallel to the ship's side and spaced apart from each other; and
combining the AR data and the surrounding image data such that the multiple first grid lines are arranged with the ship's side as a reference in a region corresponding to the water surface.

19. A non-transitory computer-readable medium having stored thereon computer-executable instructions which, when executed by processing circuitry, cause the processing circuitry to:
generate surrounding image data of a hull including a ship's side of the hull and a water surface outside the ship's side;
generate augmented reality (AR) data including grid image data having multiple first grid lines arranged parallel to the ship's side and spaced apart from each other; and
combine the AR data and the surrounding image data such that the multiple first grid lines are arranged with the ship's side as a reference in a region corresponding to the water surface.
